(19) United States
(12) Patent Application Publication
(10) Pub. No.: US 2025/0179264 A1
(43) Pub. Date: Jun. 5, 2025

(54) HIGH RESILIENCE, LOW COMPRESSION SET, ABRASION RESISTANT HYDROGENATED NITRILE BUTADIENE RUBBER (HNBR) COMPOUND FOR HIGH TEMPERATURE HIGH PRESSURE O&G APPLICATIONS

(71) Applicants: CNPC USA CORP., Houston, TX (US); BEIJING HUAMEI, INC., Beijing (CN); CHINA NATIONAL PETROLEUM CORPORATION, Beijing (CN)

(72) Inventors: Scott MENG, Houston, TX (US); Jiaxiang (Jason) REN, Houston, TX (US); Peng CHENG, Houston, TX (US); Yu LIU, Beijing (CN)

(21) Appl. No.: 18/524,448

(22) Filed: Nov. 30, 2023

(51) Int. Cl. C08K 3/04

(52) U.S. Cl. CPC C08K 3/04; C08K 2201/005; C08K 2201/011

(57) ABSTRACT

The Patent Application discloses a hydrogenated nitrile rubber. The hydrogenated nitrile rubber may comprise 100 parts by weight of hydrogenated nitrile rubber having a bound acrylonitrile content of 17% or more, a Mooney viscosity ML1+4 (100° C.) of from about 20 to about 100 and no less than 140 parts by weight in sum total as a filler comprising carbon black.

### TECHNICAL FIELD AND INDUSTRIAL APPLICABILITY

The present invention relates to a hydrogenated nitrile rubber composition and more particularly to a hydrogenated nitrile rubber composition capable of providing a high resilience, low compression set, abrasion resistant for high temperature high pressure oil and gas applications.

### BACKGROUND

Numerous hydrogenated rubber compounds have been used in oil & gas industry. For the application of multi-set packer element driven by coil tubing for hydraulic fracturing under downhole conditions, it has been found that it requires hydrogenated rubber compound to possess high resilience, low compression set and abrasion resistant properties all at the same time. The hydrogenated rubber compounds on the current market can barely meet one or two of the 3 key requirements. The challenge lies in the formulation design.

There is a need, therefore, to have a good formulation to make hydrogenated rubber which can have a high resilience, low compression set, and abrasion resistant properties.

### SUMMARY

In one aspect, one embodiment discloses a hydrogenated nitrile rubber. The hydrogenated nitrile rubber may comprise about 100 parts by weight of hydrogenated nitrile rubber having a bound acrylonitrile content of about 17% or more, a Mooney viscosity ML1+4 (100° C.) of from about 20 to about 100 and no less than about 140 parts by weight in sum total as a filler comprising carbon black.

Optionally in any aspect, the hydrogenated nitrile rubber is at least one rubber selected from rubbers obtained by hydrogenating the conjugated diene unit portion of unsaturated nitrile-conjugated diene copolymers, unsaturated nitrile/conjugated diene/ethylenically unsaturated monomer copolymers, rubbers obtained by hydrogenating the conjugated diene unit portion of unsaturated nitrile/conjugated diene/ethylenically unsaturated monomer copolymers, and unsaturated nitrile/ethylenically unsaturated monomer copolymers.

Optionally in any aspect, the filler comprises from about 40 to about 80 parts by weight of carbon black.

Optionally in any aspect, the carbon black have particle size from about 25 nm to about 35 nm.

Optionally in any aspect, the carbon black has surface area from about 75 to about 85 m²/g.

Optionally in any aspect, the carbon black has oil absorption number (OAN) from about 95 to about 110.

Further in another aspect, one embodiment discloses a hydrogenated nitrile rubber. The hydrogenated nitrile rubber comprises about 100 parts by weight of hydrogenated nitrile rubber having a bound acrylonitrile content of about 17% or more; and no less than about 140 parts by weight in sum total as a filler comprising carbon black, wherein the hydrogenated nitrile rubber is at least one rubber selected from rubbers obtained by hydrogenating the conjugated diene unit portion of unsaturated nitrile-conjugated diene copolymers, unsaturated nitrile/conjugated diene/ethylenically unsaturated monomer copolymers, rubbers obtained by hydrogenating the conjugated diene unit portion of unsaturated nitrile/conjugated diene/ethylenically unsaturated monomer copolymers, and unsaturated nitrile/ethylenically unsaturated monomer copolymers.

In yet another aspect, one embodiment discloses a hydrogenated nitrile rubber. The hydrogenated nitrile rubber comprises: about 100 parts by weight of hydrogenated nitrile rubber having a bound acrylonitrile content of about 17% or more, and no less than about 140 parts by weight in sum total as a filler comprising carbon black, wherein the carbon black has a particle size from about 25 nm to about 35 nm.

Optionally in any aspects, the bound acrylonitrile content may be from about 17% to about 50%.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1a illustrates a conventional carbon black filler system under microscope;

FIG. 1b illustrates a new carbon black filler system under microscope;

FIG. 2 illustrates a comparison of repeated compression set with a rubber having a new carbon black system and a conventional carbon black system; and

FIG. 3 illustrates a comparison of abrasion resistance with a rubber having a new carbon black system and a conventional carbon black system.

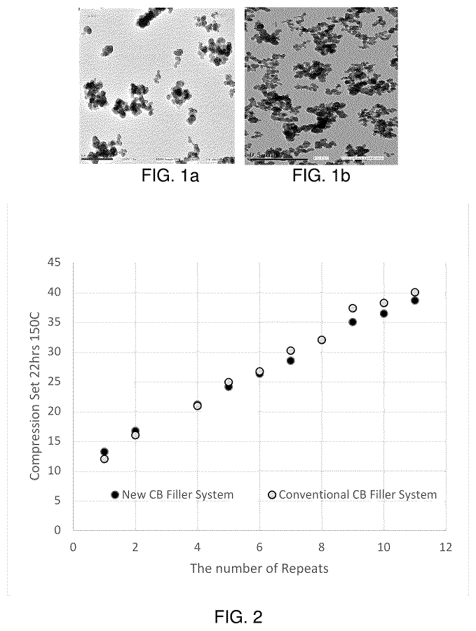

### DETAILED EMBODIMENTS

### Definitions

The term “about” means plus or minus 20%, more preferably plus or minus 10%, even more preferably plus or minus 5%, most preferably plus or minus 2%.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

The invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All percentages for weights expressed herein are by weight of the total product unless specifically stated otherwise.

The technical means, creative features, objectives, and effects of the patent application may be easy to understand, the following embodiments will further illustrate the Patent Application. However, the following embodiments are only the preferred embodiments of the utility Patent Application, not all of them. Based on the examples in the implementation manners, other examples obtained by those skilled in the art without creative work shall fall within the protection scope of the present invention. The experimental methods in the following examples are conventional methods unless otherwise specified. The materials and reagents used in the following examples can be obtained from commercial sources unless otherwise specified.

### EXEMPLARY EMBODIMENTS

Copolymerization of α,β-unsaturated nitriles with conjugated dienes and optionally one or more further copolymerizable termonomers leads to so-called nitrile rubbers (also referred to as “NBR” for short). Said copolymerization is typically carried out by an emulsion process, which firstly gives an NBR latex which is then coagulated to isolate the NBR solid using mostly salts or acids as coagulants.

Hydrogenated nitrile rubber, also referred to as “HNBR” for short, is produced by a subsequent hydrogenation of NBR. Accordingly, the C═C double bonds of the copolymerized diene units are completely or partly hydrogenated in HNBR. The degree of hydrogenation of the copolymerized diene units is usually in the range from 50 to 100%. Hydrogenated nitrile rubber is a specialty rubber which has very good heat resistance, excellent resistance to ozone and chemicals and also an excellent oil resistance. In addition, HNBR also possesses very good mechanical properties, in particular, a high abrasion resistance. HNBR has found wide use in a broad variety of applications and is used e.g. for seals, hoses, belts and damping elements in the automobile sector, also for stators, well seals and valve seals in the field of oil production and also for numerous parts in the aircraft industry, the electrical industry, machine construction and shipbuilding.

Most commercially available HNBR grades usually have a Mooney viscosity (ML 1+4 at 100° C.) in the range from 55 to 120, which corresponds to a number average molecular weight Mn (determination method: gel permeation chromatography (GPC) against polystyrene standards) in the range from about 100,000 to 500,000. The polydispersity index PDI (PDI=Mw/Mn, where Mw is the weight average molecular weight and Mn is the number average molecular weight), which indicates the width of the molecular weight distribution, measured here frequently has a value of 3 or well above. The residual double bond content is usually in the range from 0 to 18% (determined by NMR or IR spectroscopy). However, the term “fully hydrogenated grades” is used in the technical field when the residual double bond content is not more than about 0.9%.

The processability of HNBR grades having the abovementioned Mooney viscosities of up to 120 is subject to limitations. For many applications, it is desirable to have HNBR grades which have a lower molecular weight and a lower Mooney viscosity, since this significantly improves the processability. However, the preparation of HNBR having low molar masses and Mooney viscosities (ML 1+4 at 100° C.) in the range of up to about 55, has for a long time not been possible by means of established production processes mainly for two reasons: Firstly, a substantial increase in the Mooney viscosity (so-called Mooney Increase Ratio, “MIR”) occurs during hydrogenation of NBR to HNBR. This MIR is around about 2 or above, depending on the polymer grade, hydrogenation level and nature of the NBR feedstock and increases in particular with decreasing Mooney viscosity of the NBR feedstock. Secondly, the molar mass of the NBR feedstock used for the hydrogenation cannot be reduced at will since otherwise processing in the available industrial plants is no longer possible because of excessive high stickiness. The lowest Mooney viscosity of a NBR feedstock which can be processed without difficulties in an established industrial plant is in the range of about 25 Mooney units (ML 1+4 at 100° C.). This lower limit will increase with increasing ACN content of the NBR since the stickiness will rise with the ACN content. The Mooney viscosity of the HNBR obtained therefrom is in the order of 55 and more Mooney units (ML 1+4 at 100° C.). The Mooney viscosity is determined in accordance with ASTM Standard D 1646.

The process according to the present embodiment uses hydrogenated nitrile rubbers as starting rubbers comprising repeating units derived from at least one conjugated diene, at least one α,β-unsaturated nitrile and, if desired, one or more further copolymerizable monomers, i.e. either copolymers or terpolymers having a viscosity of at maximum 20.000 Pa*s (measured at 100° C. and a shear rate of 1/s), preferably at maximum 10.000 Pa*s, more preferably at maximum 5.000 Pa*s and most preferably at maximum 1.000 Pa*s.

The term “derived from” shall mean that in case of the repeating units of the conjugated diene the carbon-carbon double bonds are partially or completely hydrogenated. The hydrogenated nitrile rubbers are obtained by hydrogenating the corresponding nitrile rubbers.

The conjugated diene can be of any nature. Preference is given to using (C4-C6) conjugated dienes. Particular preference is given to 1,3-butadiene, isoprene, 2,3-dimethylbutadiene, piperylene or mixtures thereof. Very particular preference is given to 1,3-butadiene and isoprene or mixtures thereof. Especial preference is given to 1,3-butadiene.

As α,β-unsaturated nitrile, it is possible to use any known α,β-unsaturated nitrile, preferably a (C3-C5) α,μ-unsaturated nitrile such as acrylonitrile, methacrylonitrile, ethacrylonitrile or mixtures thereof. Particular preference is given to acrylonitrile.

A particularly preferred hydrogenated nitrile rubber is thus a copolymer having repeating units derived from acrylonitrile and 1,3-butadiene.

Apart from the conjugated diene and the α,β-unsaturated nitrile, the hydrogenated nitrile rubber may comprise repeating units of one or more further copolymerizable monomers known in the art, e.g. α,β-unsaturated (preferably mono-unsaturated) monocarboxylic acids, their esters and amides, α,β-unsaturated (preferably mono-unsaturated)dicarboxylic acids, their mono-oder diesters, as well as the respective anhydrides or amides of said α,β-unsaturated dicarboxylic acids.

As α,β-unsaturated monocarboxylic acids acrylic acid and methacrylic acid are preferably used.

Esters of α,β-unsaturated monocarboxylic acids may also be used, in particular alkyl esters, alkoxyalkyl esters, aryl esters, cycloalkylesters, cyanoalkyl esters, hydroxyalkyl esters, and fluoroalkyl esters.

As alkyl esters C1-C18 alkyl esters of the α,β-unsaturated monocarboxylic acids are preferably used, more preferably C1-C18 alkyl esters of acrylic acid or methacrylic acid, such as methylacrylate, ethylacrylate, propylacrylate, n-butylacrylate, tert.-butylacrylate, 2-ethylhexylacrylate, n-dodecylacrylate, methylmethacrylate, ethylmethacrylate, propylmethacrylate, n-butylmethacrylate, tert.-butylmethacrylate and 2-ethylhexyl-methacrylate.

As alkoxyalkyl esters C1-C18 alkoxyalkyl esters of α,β-unsaturated monocarboxylic acids are preferably used, more preferably alkoxyalkylester of acrylic acid or methacrylic acid such as methoxy methyl(meth)acrylate, methoxy ethyl(meth)acrylate, ethoxyethyl(meth)acrylate and methoxyethyl(meth)acrylate.

It is also possible to use aryl esters, preferably C6-C₁₄-aryl-, more preferably C6-C10-aryl esters and most preferably the aforementioned aryl esters of acrylates and methacrylates.

In another embodiment cycloalkyl esters, preferably C5-C12-cycloalkyl-, more preferably C6-C12-cycloalkyl and most preferably the aforementioned cycloalkyl acrylates and methacrylates are used.

It is also possible to use cyanoalkyl esters, in particular cyanoalkyl acrylates or cyanoalkyl methacrylates, in which the number of C atoms in the cyanoalkyl group is in the range of from 2 to 12, preferably α-cyanoethyl acrylate, β-cyanoethyl acrylate or cyanobutyl methacrylate are used. In another embodiment, hydroxyalkyl esters are used, in particular hydroxyalkyl acrylates and hydroxyalkyl methacrylates in which the number of C-atoms in the hydroxylalkyl group is in the range of from 1 to 12, preferably 2-hydroxyethyl acrylate, 2-hydroxyethyl methacrylate or 3-hydroxypropyl acrylate.

It is also possible to use fluorobenzyl esters, in particular fluorobenzyl acrylates or fluorobenzyl methacrylates, preferably trifluoroethyl acrylate and tetrafluoropropyl methacrylate. Substituted amino group containing acrylates and methacrylates may also be used like dimethylaminomethyl acrylate and diethylaminoethylacrylate.

Various other esters of the α,β-unsaturated carboxylic acids may also be used, like e.g. polyethyleneglycol(meth)acrylate, polypropyleneglycole(meth)acrylate, glycidyl(meth)acrylate, epoxy(meth)acrylate, N-(2-hydroxyethyl) acrylamide, N-(2-hydroxymethyl) acrylamide or urethane(meth)acrylate.

It is also possible to use mixture of all aforementioned esters of α,β-unsaturated carboxylic acids.

Furthermore, α,β-unsaturated dicarboxylic acids may be used, preferably maleic acid, fumaric acid, crotonic acid, itaconic acid, citraconic acid and mesaconic acid.

In another embodiment anhydrides of 4-unsaturated dicarboxylic acids are used, preferably maleic anhydride, itaconic anhydride, citraconic anhydride and mesaconic anhydride.

In a further embodiment mono- or diesters of α,β-unsaturated dicarboxylic acids can be used. Suitable alkyl esters are e.g. C1-C10-alkyl, preferably ethyl-, n-propyl-, iso-propyl, n-butyl-, tert.-butyl, n-pentyl-oder n-hexyl mono- or diesters. Suitable alkoxyalkyl esters are e.g. C2-C12 alkoxyalkyl-, preferably C3-C8-alkoxyalkyl mono- or diesters. Suitable hydroxyalkyl esters are e.g. C1-C12 hydroxyalkyl-, preferably C2-C8-hydroxyalkyl mono- or diesters. Suitable cycloalkyl esters are e.g. C5-C12-cycloalkyl-, preferably C6-C12-cycloalkyl mono- or diesters. Suitable alkylcycloalkyl esters are e.g. C6-C12-alkylcycloalkyl-, preferably C7-C10-alkylcycloalkyl mono- or diesters. Suitable aryl esters are e.g. C6-C14-aryl, preferably C6-C10-aryl mono- or diesters.

Explicit examples of the α,β-ethylenically unsaturated dicarboxylic acid monoester monomers include maleic acid monoalkyl esters, preferably monomethyl maleate, monoethyl maleate, monopropyl maleate, and mono n-butyl maleate;
maleic acid monocycloalkyl esters, preferably monocyclopentyl maleate, monocyclohexyl maleate, and monocycloheptyl maleate;
maleic acid monoalkylcycloalkyl esters, preferably monomethylcyclopentyl maleate, and monoethylcyclohexyl maleate;
maleic acid monoaryl ester, preferably monophenyl maleate;
maleic acid mono benzyl ester, preferably monobenzyl maleate;
fumaric acid monoalkyl esters, preferably monomethyl fumarate, monoethyl fumarate, monopropyl fumarate, and mono n-butyl fumarate;
fumaric acid monocycloalkyl esters, preferably monocyclopentylarate, monocyclohexyl fumarate, and monocycloheptyl fumarate;
fumaric acid monoalkylcycloalkyl esters, preferably monomethylcyclopentyl fumarate, and monoethylcyclohexyl fumarate;
fumaric acid monoaryl ester, preferably monophenyl fumarate;
fumaric acid mono benzyl ester, preferably rnonobenzyl fumarate;
citraconic acid monoalkyl esters, preferably monomethyl citraconate, monoethyl citraconate, monopropyl citraconate, and mono n-butyl citraconate;
citraconic acid monocycloalkyl esters, preferably monocyclopentyl citraconate, monocyclohexyl citraconate, and monocycloheptyl citraconate;
citraconic acid monoalkylcycloalkyl esters, preferably monomethylcyclopentyl citraconate, and monoethylcyclohexyl citraconate;
citraconic acid mono aryl ester, preferably monophenyl citraconate;
citraconic acid mono benzyl ester, preferably monohenzyl citraconate;
itaconic acid mono alkyl esters, preferably monomethyl itaconate, monoethyl itaconate, monopropyl itaconate, and mono n-butyl itaconate;
itaconic acid monocycloalkyl esters, preferably monocyclopentyl itaconate, monocyclohexyl itaconate, and monocycloheptyl itaconate;
itaconic acid monoalkylcycloalkyl esters, preferably monomethylcyclopentyl itaconate, and monoethylcyclohexyl itaconate;
itaconic acid mono aryl ester, preferably monophenyl itaconate;
itaconic acid mono benzyl ester, preferably monobenzyl itaconate.

As α,β-ethylenically unsaturated dicarboxylic acid diester monomers the analogous diesters based on the above explicitly mentioned mono ester monomers may be used, wherein, however, the two organic groups linked to the C═O group via the oxygen atom may be identical or different.

As further termonomers vinyl aromatic monomers like styrol, α-methylstyrol and vinylpyridine, as well as non-conjugated dienes like 4-cyanocyclohexene and 4-vinylcyclohexene, as well as alkenes like 1- or 2-butene may be used.

The proportions of conjugated diene and α,β-unsaturated nitrile in the HNBR polymers to be used can vary within wide ranges. The proportion of or of the sum of the conjugated dienes is usually in the range from 40 to 90% by weight, preferably in the range from 50 to 85% by weight, based on the total polymer. The proportion of or of the sum of the α,β-unsaturated nitriles is usually from 10 to 60% by weight, preferably from 15 to 50% by weight, based on the total polymer. The proportions of the monomers in each case add up to 100% by weight. The additional monomers can be present in amounts of from 0 to 40% by weight, preferably from 0.1 to 40% by weight, particularly preferably from 1 to 30% by weight, based on the total polymer. In this case, corresponding proportions of the conjugated diene or dienes and/or of the α,β-unsaturated nitrile or nitriles are replaced by the proportions of the additional monomers, with the proportions of all monomers in each case adding up to 100% by weight.

The nitrile-group-containing high saturated polymer rubber used in this invention includes rubbers obtained by hydrogenating the conjugated diene unit portions of unsaturated nitrile-conjugated diene copolymer rubbers, unsaturated nitrile-conjugated diene-ethylenic unsaturated monomer ternary copolymer rubbers, rubbers obtained by hydrogenating the conjugated diene unit portions of the ternary copolymer rubbers, unsaturated nitrile-ethylenic unsaturated monomer copolymer rubbers. These nitrile-group-containing highly saturated polymer rubbers can be obtained by a conventional polymerization method and a conventional hydrogenation method, but needless to say, a method for producing said rubber is not critical in the present invention. Although not critical, the content of unsaturated nitrile in the nitrile-group-containing highly saturated polymer rubber is usually in the range of 10 to 60% by weight.

Examples of monomers used for producing nitrile-group-containing highly saturated polymer rubbers described above are given below.

The unsaturated nitriles may include acrylonitrile, methacrylonitrile. The conjugated diene, include 1,3-butadiene, 2,3-dimethylbutadiene, isoprene, 1,3-pentadiene. The ethylenic unsaturated monomers include, for example, vinyl aromatic compounds such as styrene, chlorostyrene, p-t-butyl-styrene, chloromethylstyrene; esters of unsaturated carboxylic acids, such as methyl acrylate, 2-ethylhexyl acrylate; alkoxyalkyl esters of the aforesaid unsaturated carboxylic acids, such as methoxymethyl acrylate, ethoxyethyl acrylate, methoxyethoxyethyl acrylate; unsaturated carboxylic acid amides such as acrylamide, methacrylamide; and N-substituted(meth)acrylamide such as N-methylol(meth)acrylamide, N,N′-dimethylol(meth)acrylamide, N-ethoxymethyl(meth)acrylamide.

For producing the unsaturated nitrile-ethylenic unsaturated monomer copolymer rubbers, a non-conjugated diene such as vinylnorbornene, dicyclopentadiene, 1,4-hexadiene may be copolymerized in place of a portion of said unsaturated monomer.

Specific examples of the nitrile-group-containing highly saturated polymer rubber used in this invention may include hydrides of butadiene-acrylonitrile copolymer rubbers, isoprene-butadiene-acrylonitrile copolymer rubbers, and isoprene-acrylonitride copolymer rubbers; butadiene-methylacrylate-acrylonitrile copolymer rubbers, butadiene-styrene-acrylonitrile copolymer rubbers, and hydrides thereof; and butadiene-ethylene-acrylonitrile copolymer rubbers, butyl acrylate-ethoxyethyl acrylate-vinyl chloroacetate-acrylonitrile copolymer rubbers, and butyl acrylate-ethoxyethyl acrylate-vinylnorbonene-acrylonitrile copolymer rubbers.

### Carbon Black

The size of the primary particles controls the surface area, but the shape/structure of the aggregates is also important. The structure of carbon black is quantified using the oil absorption number (OAN). The OAN is a measure of the number of primary particles that are fused together and more specifically the amount of intra-aggregate void volume of the nano-structured aggregates. The OAN is measured through the dripping of oil at a constant rate into a cylinder containing carbon black. The cylinder contains the carbon black and two rotors that are moving at constant speed. The torque required to turn the rotors reaches a maximum where the entirety of the void volume between the aggregates has been filled. The curve is fitted to a quadratic and a pre-determined method of calculating the OAN value is used to give the official OAN or structure value. Compressed OAN or COAN uses the same absorption method, however, the carbon black pellets are submitted to extreme pressure in a piston four times prior to the measurement. In this way, the pellets are compressed or crushed in a way that is supposed to mimic the crushing or shearing in the rubber processing equipment. Another method for measuring the mesoporosity or intra-aggregate volume is to perform mercury porosimetry which can provide more detail than the typical OAN test.

Carbon black is mostly carbon arranged in small stacks of graphene sheets. A crystal within carbon black can be envisaged as a cube approximately 1.5×1.5×1.5 nm (slight function of CB type but not as much as primary particle size). For simplicity, the carbon black can be envisioned as 4-5 sheets of graphene on top of each other for the typical crystallite size of graphene in carbon black. The length scale of these crystallites in the stacking direction is Lc. A primary particle can be thought of as hundreds or thousands of these cubes packed together in such a way as to make a spherical ball. The interior of this ball is known to be more amorphous and the exterior is known to be more graphitic.

Carbon black has been described as quasi-crystalline. In typical graphite, the graphene sheets are stacked in such a way that there is A-B-A-B repeated stacking like a very ordered deck of cards. In carbon black, the stacking is characterized as turbostratic, which means that the graphene sheets are not aligned so as to allow the lowest energy overlap between the pi orbitals of the intervening layers, and this causes the interlayer spacing (d002) to change from the value found in graphite of 0.334 nm to values for carbon black in the 0.35 to 0.36 nm range. The most likely reason for the turbostratic structure is that the manufacturing process for furnace carbon black involves heating oil feedstock in an oxygen-limited atmosphere to temperatures in excess of 1600° C. and then immediately quenching the process fractions of a second after it has started. This kinetically freezes the layers in place in a disordered fashion. Crystallinity of carbon black can be measured by powder X-ray diffraction or Raman spectroscopy.

CB aggregates can fracture during mixing and bound rubber increases as mixing time is increased. These changes are correlated with enhancements in mechanical reinforcement.

It is generally noted that stress-strain properties of CB-filled rubber correlate better with COAN than OAN, suggesting that the high-pressure compression used in the COAN test for CB characterization mimics the CB structure breakdown during rubber mixing. The CB aggregates may breakdown during mixing, and this reduction in aggregate size during rubber compounding is generally greater for higher structure carbon blacks, stronger polymer-filler interactions, and more intensive mixing processes (longer time, higher torque). The COAN test method involves compressing a CB sample four times at a pressure of 165 MPa before performing the oil absorption experiment. Not all CB aggregates are expected to be exposed to this high pressure, since it is known that jammed particle-particle force chains involving a fraction of the particles can shield stresses from the remainder of the particle population in granular materials. Due to the shear-thinning nature of viscosity for polymer melts, it is difficult to generate shear stresses in excess of approximately 10 MPa in elastomers at processing temperatures, even when highly loaded with viscosity-boosting. Due to the nearly incompressible nature of rubber, hydrostatic (volume) compression—which could occur in thin layers of polymer between filler particles in a rubber compound—can produce stresses in the GPa range. Additionally, the typical pressure and shear stress values for compounding of rubber in internal mixers and two-roll mills are continuum values that do not consider the nano- and micro-mechanics in the complex polymer-particle composite; local microscopic stresses could be significantly higher.

The HNBR rubber compound in the invention is generally formulated with gum HNBR polymers with Acrylonitrile content ranging from 17 to 50%, Mooney viscosity ML (1+4) 100° C. ranging from 20-100, residual double bonds ranging from 0 to 20%, along with the CB fillers mentioned in Table 1, as well as other additives (i.e., stabilizers, plasticizers, process aids, activators, and curatives).

The preparation of the HNBR rubber compound is generally done by using an internal mixer (i.e., Banbury type) or a two-roll mill. All the ingredients are added to the mixing equipment following a certain order and mixed under a given amount of time. Afterwards, the compounded rubber is fed to the machines (i.e., compression molding press) to form rubber articles or rubber goods (i.e., packer element).

### Experimental

A BR-1600 Banbury® laboratory mixer (“BR1600” mixer; Farrel Corporation, Ansonia, Conn.) was used to make the compound. The BR1600 mixer was operated with two 2-wing, tangential rotors (2 WL), providing a capacity of 1.6 L. The ingredients used for preparing the mixtures of rubbers and carbon black are shown in Table 1 and Table 2.

TABLE 1

| Ingredients | Formulation 1 | Formulation 2 |
|---|---|---|
| HNBR | 100 | 100 |
| Conventional CB filler system | 50-90 | |
| New CB filler system | | 40-80 |
| Stabilizers | 1-5 | 1-5 |
| Plasticizers | 5-10 | 5-10 |
| Process aids | 1-5 | 1-5 |
| Activators | 5-10 | 5-10 |
| Curatives | 7-12 | 7-12 |

TABLE 2

| | Particle Size | Surface Area | Structure |
|---|---|---|---|
| Filler System | (nm) | (m²/g) | (ml/100 g) OAN |
| Conventional | 40-50 | 35-45 | 115-130 |
| New | 25-35 | 75-85 | 95-110 |

### Process for Preparing Composites

### Compound Preparation

The formulation used in the experimental compound is set forth in Table 1. Components used include antioxidants 6PPD [N-(1,3-dimethylbutyl)-N′-phenyl-p-phenylenediamine] and TMQ, standard rubber grades of zinc oxide, stearic acid, wax beads, sulfur and TBBS accelerator, all obtained from Akrochem, Akron, Ohio. The solid dry rubber had a moisture content of <1 wt %.

### Test Results

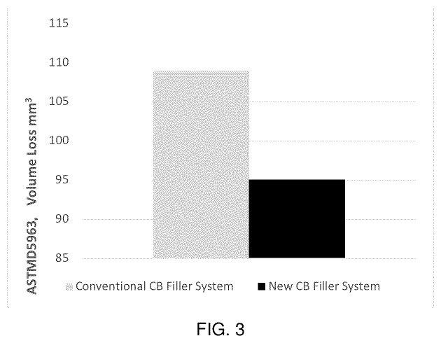

The compression set for the compounds in this Example was measured using ASTM D395-16e1, Method B. The conditions for these tests included aging button specimens for 22 hours at 150° C., using a deflection of 25%, and 0.5 hour recovery time. As shown in FIG. 3, the number of repeats are 1, 2, 4, 5, 6, 7, 8, 9, 10, and 11. The average compression set for two rubber compounds was similar from repeats up to 8 with an exception of 7. After repeat 8, the rubber with new carbon black system performs much better than the rubber with a convention carbon black system.

The abrasion resistant of the compounds in this Example were measured using ASTM D5963-04 (2015) testing standards with control abrasive Grade 177, and 40 rpm and 10 N load conditions. Three samples were measured for each. The average abrasion loss of the three rubber with conventional carbon black samples was 108 mm³ (with a standard deviation of 6.8 mm³). The experimental compounds with new carbon black system had much lower abrasion loss of 95 mm³ (with standard deviation of 8.7 mm³) compared to the rubber with conventional carbon black samples.

The HNBR compound developed can be used for making packer elements, which may be driven down by coil tubing and go through multiple set-unset cycles during the downhole operation. The number of cycles a packer element can repeat, and the sealing performance ultimately depends upon the compound properties. The more cycles the packer element goes through, the more cost effective it is for hydraulic fracturing operations. The compound may also be potential fit for the application of ‘blow out preventers, among others.

Other modifications and variations of the hydrogenated nitrile rubber materials will be apparent to those skilled in the art. It is, therefore, to be understood that within the scope of the appended claims, this invention may be practiced otherwise than as specifically described. Although only a few exemplary embodiments of this invention have been described in detail above, those skilled in the art will readily appreciate that many modifications are possible in the exemplary embodiments without materially departing from the novel teachings and advantages of this invention.

Accordingly, all such modifications are intended to be included within the scope of this invention as defined in the following claims. In the claims, no clauses are intended to be in the means-plus-function format allowed by 35 U.S.C. § 112, paragraph 6 unless “means for” is explicitly recited together with an associated function. “Means for” clauses are intended to cover the structures described herein as performing the recited function and not only structural equivalents, but also equivalent structures.

The above shows and describes the basic principles, main features and advantages of the utility Patent Application. Those skilled in the industry should understand that the present utility Patent Application is not limited by the above-mentioned embodiments. The above-mentioned embodiments and the description are only preferred examples of the present utility patent application and are not intended to limit the present utility Patent Application, without departing from the present utility Patent Application. Under the premise of spirit and scope, the present utility patent application will have various changes and improvements, and these changes and improvements fall within the scope of the claimed utility Patent Application. The scope of protection claimed by the utility patent application is defined by the appended claims and their equivalents.

We claim:

1. A hydrogenated nitrile rubber, comprising:
about 100 parts by weight of hydrogenated nitrile rubber having a bound acrylonitrile content of about 17% or more, a Mooney viscosity ML₁₊₄ (100° C.) of from about 20 to about 100 and no less than about 140 parts by weight in sum total as a filler comprising carbon black.

2. A hydrogenated nitrile rubber according to claim 1, wherein the hydrogenated nitrile rubber is at least one rubber selected from rubbers obtained by hydrogenating the conjugated diene unit portion of unsaturated nitrile-conjugated diene copolymers, unsaturated nitrile/conjugated diene/ethylenically unsaturated monomer copolymers, rubbers obtained by hydrogenating the conjugated diene unit portion of unsaturated nitrile/conjugated diene/ethylenically unsaturated monomer copolymers, and unsaturated nitrile/ethylenically unsaturated monomer copolymers.

3. A hydrogenated nitrile rubber according to claim 1, wherein the filler comprises from about 40 to about 80 parts by weight of carbon black.

4. A hydrogenated nitrile rubber according to claim 1, wherein the carbon black have particle size from about 25 nm to about 35 nm.

5. A hydrogenated nitrile rubber according to claim 1, wherein the carbon black has surface area from about 75 to about 85 m²/g.

6. A hydrogenated nitrile rubber according to claim 1, wherein the carbon black has off absorption number (OAN) from about 96 to about 110.

7. A hydrogenated nitrile rubber, comprising: about 100 parts by weight of hydrogenated nitrile rubber having a bound acrylonitrile content of about 17% or more; and no less than about 140 parts by weight in sum total as a filler comprising carbon black, wherein the hydrogenated nitrile rubber is at least one rubber selected from rubbers obtained by hydrogenating the conjugated diene unit portion of unsaturated nitrile-conjugated diene copolymers, unsaturated nitrile/conjugated diene/ethylenically unsaturated monomer copolymers, rubbers obtained by hydrogenating the conjugated diene unit portion of unsaturated nitrile/conjugated diene/ethylenically unsaturated monomer copolymers, and unsaturated nitrile/ethylenically unsaturated monomer copolymers.

8. A hydrogenated nitrile rubber according to claim 7, wherein
hydrogenated nitrile rubber has a Mooney viscosity ML₁₊₄ (100° C.) of from about 20 to about 100.

9. A hydrogenated nitrile rubber composition according to claim 7, wherein the filler comprises from about 40 to about 80 parts by weight of carbon black.

10. A hydrogenated nitrile rubber according to claim 7, wherein the carbon black have particle size from about 25 nm to about 35 nm.

11. A hydrogenated nitrile rubber according to claim 7, wherein the carbon black has surface area from about 75 to about 85 m²/g.

12. A hydrogenated nitrile rubber according to claim 7, wherein the carbon black has oil absorption number (OAN) from about 95 to about 110.

13. A hydrogenated nitrile rubber, comprising: about 100 parts by weight of hydrogenated nitrile rubber having a bound acrylonitrile content of about 17% or more, and no less than about 140 parts by weight in sum total as a filler comprising carbon black, wherein the carbon black has a particle size from about 25 nm to about 35 nm.

14. A hydrogenated nitrile rubber according to claim 13, wherein the hydrogenated nitrile rubber is at least one rubber selected from rubbers obtained by hydrogenating the conjugated diene unit portion of unsaturated nitrile-conjugated diene copolymers, unsaturated nitrile/conjugated diene/ethylenically unsaturated monomer copolymers, rubbers obtained by hydrogenating the conjugated diene unit portion of unsaturated nitrile/conjugated diene/ethylenically unsaturated monomer copolymers, and unsaturated nitrile/ethylenically unsaturated monomer copolymers.

15. A hydrogenated nitrile rubber according to claim 13, wherein the hydrogenated nitrile rubber has a Mooney viscosity ML₁₊₄ (100° C.) of from about 20 to about 100.

16. A hydrogenated nitrile rubber according to claim 13, wherein the bound acrylonitrile content of from about 17% to about 50%.

17. A hydrogenated nitrile rubber according to claim 13, wherein the filler comprises from about 40 to about 80 parts by weight of carbon black.

18. A hydrogenated nitrile rubber according to claim 13, wherein the carbon black has particle size from about 26 nm to about 35 nm.

19. A hydrogenated nitrile rubber according to claim 13, wherein the carbon black has surface area from about 75 to about 85 m²/g.

20. A hydrogenated nitrile rubber according to claim 13, wherein the hydrogenated nitrile rubber comprises hydrogenated nitrile butadiene rubber (HNBR).
